(19) United States
(12) Patent Application Publication
(10) Pub. No.: US 2006/0210850 A1
(43) Pub. Date: Sep. 21, 2006

(54) Method, system and apparatus for diagnostic testing of an electrochemical cell stack

(76) Inventors: Rami Michel Abouatallah, Toronto (CA); Stephane Masse, Toronto (CA); Daren Pemberton, Mississauga (CA)

Correspondence Address: BERESKIN AND PARR, 40 KING STREET WEST, BOX 401, TORONTO, ON, M5H 3Y2, CA

(21) Appl. No.: 11/081,521

(22) Filed: Mar. 17, 2005

(51) Int. Cl. H01M 8/04

(52) U.S. Cl. 429/22; 429/34; 429/13

(57) ABSTRACT

Embodiments of the pertinent invention relates to apparatus, systems and methods for diagnostic testing of an electrochemical cell stack, such as a fuel cell stack or an electrolyzer cell stack. According to one embodiment, the apparatus comprises a multiplexer for switching current to one or more cells in the electrochemical cell stack, a voltage monitor for monitoring the voltage between the anode plate and the cathode plate of one or more cells, a power supply module for supplying power to the multiplexer and a gas supply module for supplying fuel gas and non-fuel gas to the electrochemical cell stack. The apparatus further comprises a control module electrically connected to and configured to control the multiplexer, the voltage monitor, the power supply module and the gas supply module to conduct automatic diagnostic testing of the electrochemical cell stack. The control module is further configured to determine, through the diagnostic testing, whether the electrochemical cell stack has one or more gas leaks. If one or more gas leaks is detected, the control module determines which of the one or more cells is affected by the gas leak. The control module is further configured to determine a degree of crossover of electrochemical reactant through the membrane of each cell and whether any of these cells is likely to be short-circuited.

### FIELD OF THE INVENTION

The present invention relates to a method, system and apparatus for diagnostic testing of an electrochemical cell stack. In particular, the invention relates to automatic diagnostic testing of an electrochemical cell stack involving leak testing, short circuit testing and electrochemical cross-over testing.

### BACKGROUND OF THE INVENTION

Fuel cells and electrolyzer cells are usually collectively referred to as electrochemical cells. Fuel cell-based systems are seen as an increasingly promising alternative to traditional power generation technologies, at least in part due to their low emissions, high efficiency and ease of operation. Generally, fuel cells operate to convert chemical energy into electrical energy. One form of fuel cell employs a proton exchange membrane (PEM), where the fuel cell comprises an anode, a cathode and a selective electrolytic membrane disposed between these two electrodes.

In a catalyzed reaction, a fuel such as hydrogen is oxidized at the anode to form cations (protons) and electrons. The proton exchange membrane facilitates the migration of protons from the anode to the cathode. The electrons cannot pass through the membrane and are forced to flow through an external circuit, thus providing an electrical current. At the cathode, oxygen reacts at the catalyst layer with electrons returned from the electrical circuit to form anions. The anions formed at the cathode react with the protons that have crossed the PEM to form liquid water as the reaction product, known as product water.

An electrolyzer cell uses electricity to electrolyze water to generate oxygen from its anode and hydrogen from its cathode. Similar to a fuel cell, a typical solid polymer water electrolyzer (SPWE) or proton exchange membrane (PEM) electrolyzer is also comprised of an anode, a cathode and a proton exchange membrane disposed between the two electrodes. Water is introduced to, for example, the anode of the electrolyzer which is connected to the positive pole of a suitable direct current voltage. Oxygen is produced at the anode by the reaction: H₂O=½ O₂+2H⁺+2e⁻.

The protons then migrate from the anode to the cathode through the membrane. On the cathode which is connected to the negative pole of the direct current voltage, the protons conducted through the membrane are reduced to hydrogen following the reaction: 2H⁺+2e⁻=H₂.

Fuel cell systems normally employ a series of fuel cells together in what is called a fuel cell stack. Prior to installing a fuel cell stack in a fuel cell-based power generation system, it is desirable to test the stack to ensure that it functions properly and will operate within the appropriate operating parameters. It may also be desirable to perform such testing as a part of a diagnostic process once the stack has been in used for some time, for example where the stack performance appears to be sub-standard.

Other electrochemical cells, such as electrolyzer cells, may be similarly arranged in series to form an electrolyzer cell stack. Testing of such electrolyzer cell stacks is also desirable, for example for diagnostic or quality assurance purposes.

Testing systems for electrochemical cells have been developed. One such testing system is the fuel cell automatic test station (FCATS), developed by Hydrogenics Corporation. The FCATS is a sophisticated testing system which allows a fuel cell or fuel cell stack to be tested in isolation. The FCATS provides a range of tests and provides full reactant feeds, ensures an appropriate operating environment (e.g. appropriate humidity levels of the air supply to the cathode) and monitors various process parameters and conditions as the fuel cell or fuel cell stack is running. The FCATS is not, however, designed for automatic diagnostic testing of electrochemical cell stacks that are not operating to consume reactants.

Common problems in electrochemical cell stacks include short-circuiting between the anode and cathode of individual cells within the stack, leakage of gases between the anode, cathode or coolant chambers of the cells, as well as electrochemical cross-over of reactants anode to cathode or vice versa. Current manual methods for conducting each of these tests are cumbersome and are prone to human error. Further, each of the tests for these problems is conducted separately on separate makeshift or dedicated apparatus.

Further, where it is desired to provide current to one or more cells in an electrochemical stack, it would be desirable to provide some means by which current may be readily switched between a current source and the various electrochemical cells to which current is to be supplied. However, most available switching-element integrated circuits are designed for telecommunications applications and are not suited to supplying the higher current required for electrochemical cells because of their prepackaged low-current switching transistors. On the other hand, relays may be used for switching currents to the electrochemical cells as they can handle higher current levels. However, relays take up a relatively large amount of space on a printed circuit board and introduce additional mechanical complexities and reliability issues.

It is an object of the present invention to address or ameliorate one or more shortcomings or disadvantages associated with existing systems, apparatus or methods for testing electrochemical cell stacks, or to at least provide a useful alternative thereto.

### SUMMARY OF THE INVENTION

Aspects of the invention are generally directed to apparatus, systems and methods for use in automated diagnostic testing of electrochemical cell stacks.

In one aspect, the invention relates to apparatus for diagnostic testing of an electrochemical cell stack, where each cell of the stack has an anode plate, a cathode plate and a membrane therebetween. The apparatus comprises a multiplexer, a voltage monitor, a power supply module, a gas supply module and a control module. The multiplexer switches current to one or more cells in the electrochemical cell stack. The voltage monitor monitors the voltage between the anode plate and the cathode plate of one ore more cells. The power supply module supplies power to the multiplexer. The gas supply module supplies fuel gas and non-fuel gas to the electrochemical cell stack. The control module is electrically connected to each of the multiplexer, the voltage monitor, the power supply module and the gas supply module and is configured to control each of these in conducting automatic diagnostic testing of the electrochemical cell stack. The control module is configured to determine, through the diagnostic testing, whether the electrochemical cell stack has one or more gas leaks and, if so, which of the one or more cells is affected by the one or more gas leaks. The control module is further configured to determine a degree of crossover of electrochemical reactant of each cell and whether any of the cells appears to be short-circuited.

The control module preferably comprises a computer processor having computer program instructions stored in an associated memory or otherwise accessible to the computer processor. The computer program instructions, when executed by the computer processor, cause the control module to conduct the diagnostic testing.

Another aspect of the invention relates to a multiplexer for supplying current to one or more electrochemical cells in an electrochemical cell stack during diagnostic testing of the stack. The multiplexer comprises a microcontroller, a power supply circuit and a plurality of switching circuits. The power supply circuit is responsive to power control signals from the microcontroller to supply power to the plurality of switching circuits. Each switching circuit switchably supplies current to respective electrochemical cells during the diagnostic testing, in response to the switching control signals from the microcontroller.

Preferably, the switching circuits each comprise transistors for switching current to the electrochemical cells. The transistors have a relatively high current tolerance and are therefore suitable for switching current to electrochemical cells. Preferred transistors for such an application include MOSFETs.

Advantageously, certain embodiments of the invention provide a diagnostic testing system for an electrochemical cell stack. The control module of the testing system executes program instructions for controlling the gas supply module to provide gas to the electrochemical cell stack, either as part of leak testing or short-circuit testing or hydrogen crossover testing. As part of the gas leak testing, short-circuit testing and hydrogen crossover testing, the multiplexer acts as a current or voltage supply to one or more of the cells in the electrochemical cell stack. The voltage monitor measures the potential difference across the anode and cathode plates of selected one or more cells of the electrochemical cell stack in order to determine the electrical characteristics of those cells under the test conditions.

Thus, the diagnostic testing system is configured to conduct several tests in sequence, using a single gas supply module, multiplexed current or voltage supply and voltage monitor, without having to perform the tests manually and without requiring the electrochemical cell stack to be connected and disconnected for the purpose of separate testing at several different test stations. Advantageously, the diagnostic testing system provides greater efficiency and reliability of testing, while being of a reduced complexity, structure and manufacturing cost relative to the FCATS.

Advantageously, the multiplexer according to one embodiment of the invention is designed to switch current to the electrochemical cells within the stack. This is done using a series of current switching circuits within the multiplexer, each current switching circuit corresponding to a particular cell in the stack. These current switching circuits are transistor-based circuits which receive a DC voltage and, depending on signals from the multiplexer microcontroller, apply the voltage to the corresponding cell.

Advantageously, the current switching circuits avoid the need for switching using relays, with their inherent mechanical limitations on reliability and bulky, low-density packing, while providing comparable current switching capability. Existing switching element integrated circuits are relatively high-density but cannot handle the current levels required to be supplied to a fuel cell stack. Thus, the current switching circuits employed in the multiplexer advantageously provide relatively high density on a printed circuit board and, at the same time, allow currents of a higher magnitude to be switched to the various cells in the stacks.

Another aspect of the invention relates to a method of automated diagnostic testing of an electrochemical cell stack, preferably using the diagnostic testing system described above. This aspect provides a method of automated diagnostic testing of an electrochemical cell stack having a plurality of cells, each cell in the electrochemical cell stack having an anode plate, a cathode plate and a membrane therebetween and the electrochemical cell stack defining, for each cell, an anode chamber, a cathode chamber and a coolant chamber, the method comprising the steps of:
a) selectively providing non-fuel gas to one or more of the anode chamber, the cathode chamber and the coolant chamber;
b) sensing a gas flow of the non-fuel gas through a selected one or more of the anode chamber, the cathode chamber and the coolant chamber to determine whether there is at least one gas leak from one or more of the anode chamber, the cathode chamber and the coolant chamber;
c) if it is determined in step b) that there is at least one gas leak, determining which cells are affected by the at least one gas leak by performing the steps of:
   i) selectively supplying fuel and/or non-fuel gas to one or more of the anode chamber, the cathode chamber and the coolant chamber
   ii) measuring relative current and/or voltage characteristics of the cells, and
   iii) determining, for each cell, the likelihood of the cell being affected by the at least one gas leak based on the measured current and/or voltage characteristics;
d) supplying non-fuel gas to the anode chamber and the cathode chamber;
e) applying a voltage across selected cells;
f) measuring the open-circuit potential across the anode and cathode plates of each of the selected cells;
g) determining whether each of the selected cells is short-circuited based on the measured open-circuit potential of the cell relative to the measured open-circuit potential of other selected cells;
h) storing test data and determinations generated in steps b), c), f) and g); and
i) generating a diagnostic report based on the test data and determinations.

### BRIEF DESCRIPTION OF THE DRAWINGS

Embodiments of the invention are hereinafter described in further detail, by way of example only, with reference to the accompanying drawings, in which:

FIG. 1 is a block diagram of a diagnostic testing system according to an embodiment of the invention;

FIG. 2A is a block diagram of an example gas supply module of the diagnostic testing of system of FIG. 1;

FIG. 2B is a block diagram of another example gas supply module of the diagnostic testing system of FIG. 1;

FIG. 3 is a block diagram of an example control module of the diagnostic testing system of FIG. 1;

FIG. 4 is a block diagram showing an example multiplexer of the diagnostic testing system of FIG. 1;

FIG. 5 is a circuit diagram of a switching circuit of the multiplexer;

FIG. 6 is a block diagram showing an example voltage monitor of the diagnostic testing system of FIG. 1;

FIG. 7 is a process flow diagram of a diagnostic testing method according to another embodiment of the invention; and

FIG. 8 is an exemplary plot of Measured Current versus Applied Voltage illustrating voltage-current characteristics of test data indicative of electrochemical crossover between anode and cathode chambers of a cell.

### DETAILED DESCRIPTION OF THE INVENTION

Preferred embodiments of the invention will now be described in further detail, with reference to the drawings. Like reference numerals in the drawings indicate like features or functions as between the indicated elements in the drawings.

Embodiments of the invention generally relate to automatic diagnostic testing methods, systems and apparatus for electrochemical cell stacks. The diagnostic testing may involve testing for gas leaks between the anode, cathode and coolant chambers, testing for short-circuits between the anode and cathode of each cell in the stack and testing for cross-over of electrochemical reactants between the anode and cathode or vice versa.

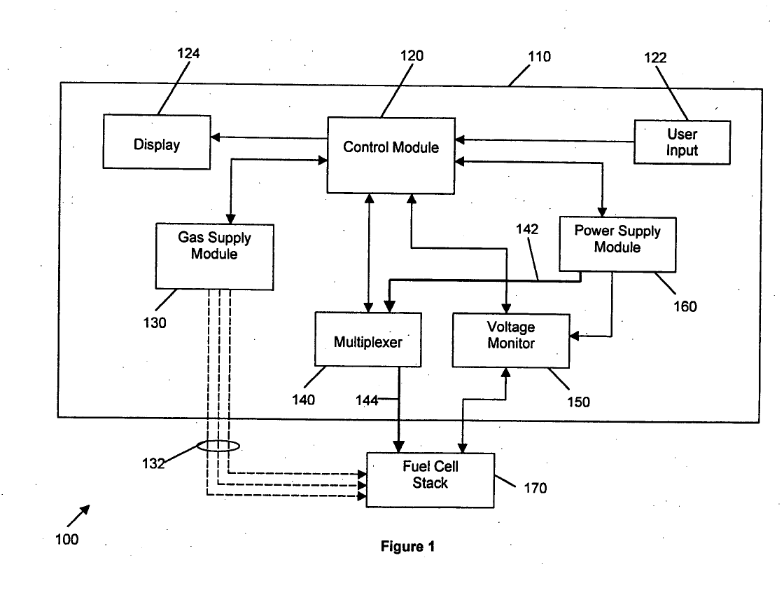

Referring now to FIG. 1, there is shown a diagnostic testing system 100. Diagnostic testing system 100 comprises a control module 120, a display 124, user input means 122, a gas supply module 130, a multiplexer 140, a voltage monitor 150 and a power supply module 160. Control module 120 provides a display output to the display 124 for displaying test data and diagnostic reports to an operator supervising the diagnostic testing. Control module also receives user input signals from the operator via the user input means 122. Such user input means includes at least a keyboard or keypad and may include a mouse and/or a touch-sensitive screen.

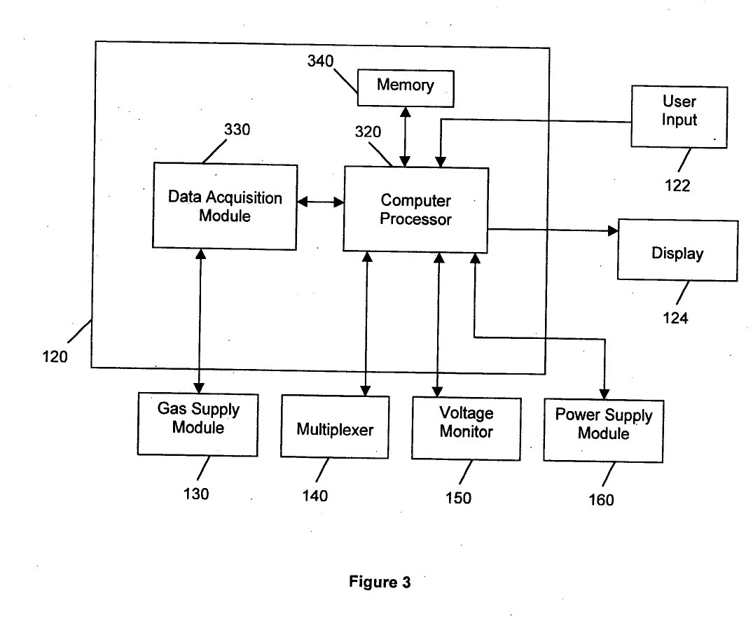

Control module 120 is electrically connected to gas supply module 130, multiplexer 140, voltage monitor 150 and power supply module 160 for communication therewith and control thereof. Control module 120 is shown and described in further detail in relation to FIG. 3.

Diagnostic testing system 100 further comprises a housing 110. Housing 110 is preferably in the form of a cabinet or cart of a relatively mobile form. The control module 120, gas supply module 130, multiplexer 140, voltage monitor 150, power supply module 160, display 124 and user input 122 are preferably all housed within housing 110. Housing 110 further comprises gas supply lines 132 running from gas supply module 130 and connectible to a fuel cell stack 170 for supplying gas thereto during the diagnostic testing.

Power supply module 160 supplies power to each of the components or modules housed in housing 110, including the control module 120, for performing their respective functions. In order to do this, power supply module 160 receives mains power (not shown) and transforms it as necessary to supply AC or DC power to the various components and modules of diagnostic testing system 100. Power supply module 160 preferably comprises a voltmeter and a multimeter (or other current measuring device) to measure its output voltage and current, respectively. Alternatively, the voltmeter and multimeter may be provided separately from the power supply module 160. The voltmeter and multimeter provide output signals to control module 120 that correspond with their measured voltage and current alues.

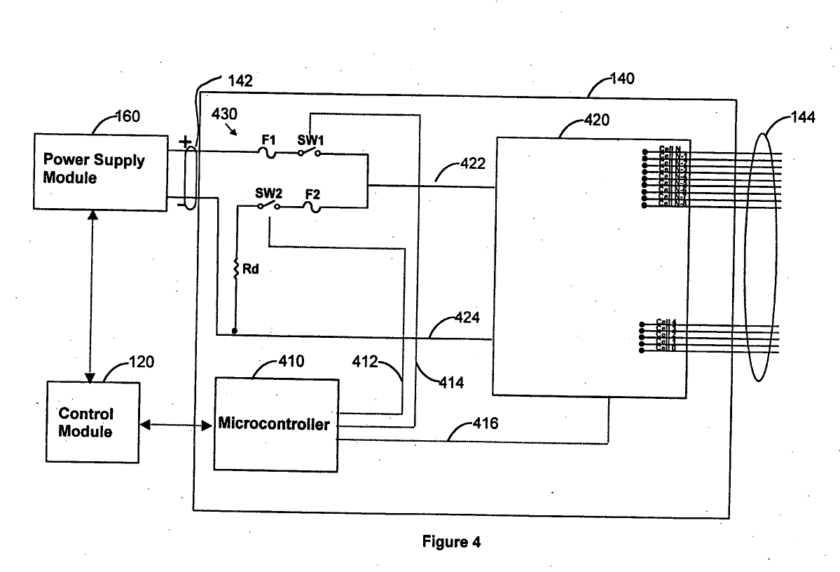

In particular, power supply module 160 supplies power to multiplexer 140 via a multiplexer power supply cable 142 and the multiplexer 140 uses this power to provide current or voltage to various of the cells in the fuel cell stack 170 via stack power supply conductors 144. Multiplexer 140 is shown and described in further detail in relation to FIG. 4.

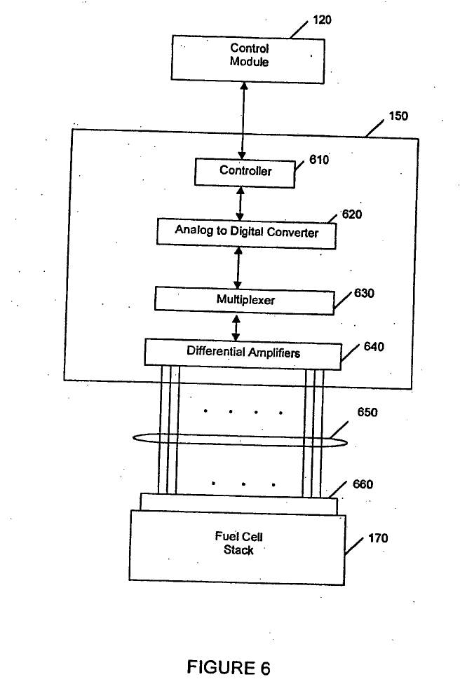

Voltage monitor 150 is used to measure the electrical potential at various of the anode or cathode plates within the cells of the fuel cell stack 170 in order to assist in determining the electrical or electrochemical performance of such cells. Voltage monitor 150 is shown and described in further detail in relation to FIG. 6.

Fuel cell stack 170 comprises at least one cell, but may have in the order of 30, 60 or 100 cells arranged in series. All such cells receive gas at their anode plates through a common anode gas conduit and receive gas at their cathode plates through a common cathode gas supply conduit. Further, coolant is supplied to all of the cells through a common coolant supply conduit. Supply lines 132 are connected to the respective inlets and outlets of these conduits for supplying gas to each of the conduits separately, depending on the particular testing step being carried out.

The various components of fuel cell stack 170 may malfunction in various ways. For example, the proton exchange membrane of a cell may have a hole in it, or the membrane and sealing gasket may incompletely separate the anode and cathode plates from each other. If there is a hole in the membrane, reactant gases may pass from the anode chamber to the cathode chamber through the hole and reduce the current generating characteristics of the cell. If the anode and cathode plates are not completely separated from one another, the cell may be short-circuited, in which case the cell would not generate normal current levels during normal operation.

When one or more cells within an electrochemical cell stack does not operate within expected operating parameters, the performance of the entire stack becomes sub-optimal. Accordingly, for quality control and quality assurance purposes, diagnostic testing of an electrochemical cell stack is desirable, in order to determine, and, if possible, correct the causes of sub-optimal performance of the stack.

During the diagnostic testing of the stack, as described herein, the stack is not operated or run in simulation. That is, unlike the FCATS, the diagnostic testing system 100 does not simulate actual operating conditions of the stack. Rather, the stack has voltages and/or currents and/or gases supplied to its cells and the resultant gas flows and/or cell voltages and/or currents are measured. Depending on the particular problem experienced by a cell in the stack, the measured cell characteristics may be different. For this reason, several different tests may be necessary in order to identify the problem experienced by that cell. For example, if a membrane imperfectly separates the cathode and anode plates of a cell because of a faulty seal, this may not be revealed by testing whether there is any gas leakage between the anode, cathode and coolant chambers of that cell. Further, if more than one diagnostic test indicates the existence or likely existence of a particular problem, this serves to increase the reliability of the test data being gathered about the stack.

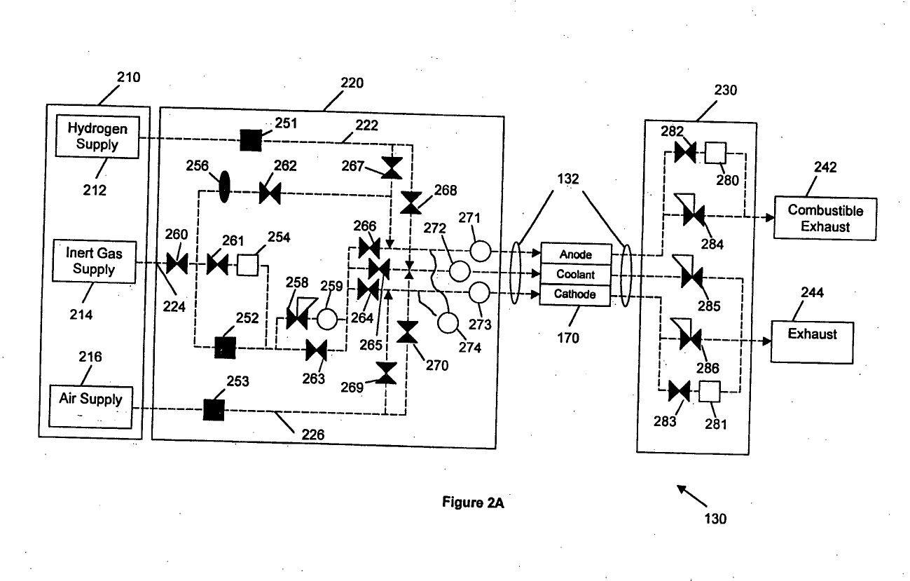

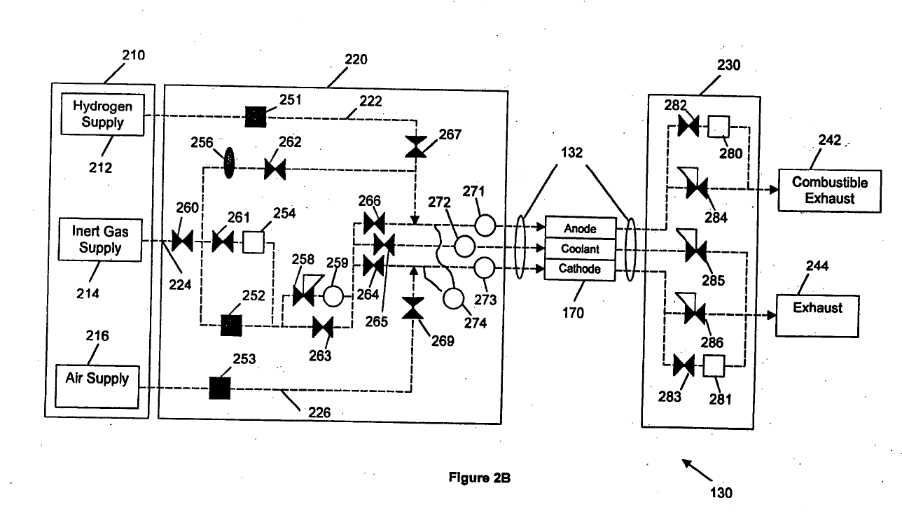

Referring now to FIG. 2A, the gas supply module 130 will be described in further detail, together with a process of use thereof, in the context of use of the diagnostic testing system 100. Gas supply module 130 comprises a gas supply 210, a flow control module 220 and a flow outlet module 230.

In use of the diagnostic testing system 100, gas supply lines 132 are connected to the inlets and outlets of the anode, cathode and coolant conduits of the electrochemical cell stack 170. Flow control module 220 controls the flow of gases to the inlets of the anode, cathode and coolant conduits, via gas supply lines 132, while flow outlet module 230 senses and controls the flow of gases from the outlets of the anode, cathode, and coolant conduits via gas supply lines 132. Gas flow through flow outlet module 230 is exhausted to exhaust 244 if it is non-combustible or to combustible exhaust 242, if it is a combustible gas, for example such as hydrogen. The flow sensing elements in module 130 are flow meters 254, 280 and 281. Other than the flow sensing provided by flow meters 280 and 281, the remaining elements in flow outlet module 230 are for flow control purposes, as described below.

Gas supply 210 comprises a hydrogen supply 212, an inert gas supply 214 and an air supply 216. Hydrogen supply 212 and inert gas supply 214 preferably comprise tanks holding hydrogen and inert gases, respectively. Example inert gases include, for example, nitrogen or helium, or other noble gases. Air supply 216 may comprise a tank of compressed air or may be derived from the air in the local environment. In either case, air from air supply 216 is preferably filtered to remove any impurities.

Flow control module 220 is connected to gas supply 210 to receive hydrogen in a hydrogen supply line 222, inert gas in an inert gas supply line 224 and air in an air supply line 226. Each of hydrogen supply line 222, inert gas supply line 224 and air supply line 226 has a respective flow controller 251, 252 and 253 for controlling the gas flow in each such supply line.

Hydrogen supply line 222 has parallel connections to the gas supply lines 132 for the anode and coolant conduits of stack 170. These parallel connections are made via a first hydrogen supply control valve 267 to the anode supply line and a second hydrogen supply control valve 268 to the coolant supply line.

Hydrogen supply flow controller 251 and first and second hydrogen supply control valves 267 and 268 (preferably solenoid valves) operate to control the flow of hydrogen from hydrogen supply 212 to the anode and coolant conduits to stack 170 via gas supply lines 132 in response to appropriate control signals from control module 120.

Flow controllers 251, 252 and 253 are preferably mass flow controllers (MFC). The control module 120 is programmed with the value of gas flow rate required for hydrogen, inert gas or air, and the corresponding MFC receives signals from the control module 120 to control the gas flow rate to the desired value.

Air supply line 226 receives air from air supply 216 and supplies it through parallel connections to the coolant and cathode supply lines via a first air supply control valve 269 and a second air supply control valve 270. Control valves 269 and 270 are preferably solenoid valves and are activated to open or close in response to control signals from the control module 120. Flow control module 220 does not allow any hydrogen to be supplied to the cathode supply line, nor does it allow air to be supplied to the anode supply line as this may result in these two reactant gases being present at the same time in any one location. The result of this might be a build-up of an unsafe (explosive) mixture of hydrogen and air.

Inert gas supply line 224 receives inert gas from inert gas supply 214 via inert gas supply control valve 260. Purge vessel 256 is filled with inert gas upon the start of diagnostic testing. It remains filled during diagnostic testing by having normally-open control valve 262 closed. Upon the end of diagnostic testing or faulty shut-down, the inert gas in purge vessel 256 is released through normally-open control valve 262 in order to flush the anode supply and exhaust lines of hydrogen (for safety purposes).

When control valve 263 is opened and control valve 261 is closed, flow controller 252 permits inert gas delivery and controls inert gas flow to the anode conduit through control valve 266, to the cathode conduit through control valve 264, or to the coolant conduit through control valve 265. The required flow rate is set by user input 122 or via a programmed test sequence run by control module 120.

Flow controller 252 is used in certain diagnostic testing (for example, short circuit testing). In other diagnostic testing (for example, leak testing), control valve 261 is opened and control valve 263 is closed. In such a this case, inert gas is supplied to the anode conduit of cell stack 170 through control valve 266, to the coolant conduit through control valve 265, or to the cathode conduit through control valve 264. This happens at a set supply pressure controlled by forward-pressure regulator 258 coupled to pressure transmitter 259. Inert gas flow in this case is indicated by flow meter 254. Flow meter 254 is preferably a mass flow meter (MFM).

Flow control module 220 further comprises first, second and third pressure transmitters 271, 272 and 273, respectively, connected in series in respective anode, coolant and cathode supply lines 132 for indicating the gas pressure in each gas supply line 132. Pressure transmitters 271, 272 and 273 are coupled to back-pressure regulators 284, 285, 286 and output analog signals to the back-pressure regulators and the control module 120, which monitors the pressure in the gas supply lines 132 during leak testing. A fourth pressure transmitter 274 is connected across the anode and cathode supply lines 132 to measure the differential pressure therebetween. Fourth pressure transmitter 274 outputs an analog signal to control module 120 to indicate this differential pressure.

There are five types of leak tests: anode-to-cathode, cathode-to-anode, coolant-to-anode, coolant-to-cathode, and external leak test. These leak tests are performed in sequence but not necessarily in the order listed. None of these leak tests indicates the specific location of the leak (for example, the cell number). Each leak test is performed on the basis of a sequence of instructions read from memory 340 (shown in FIG. 3) into computer processor 320 (shown in FIG. 3) in control module 120 or programmed via user input 122.

For the anode-to-cathode leak test, inert gas supply control valve 260 is opened and control valve 263 is closed, control valve 261 is opened, control valve 266 is opened, control valves 282 and 283 are closed, back-pressure regulators 284 and 285 are fully closed (by input of the maximum pressure value for 284 and 285), and back-pressure regulator 286 is fully opened by input of zero pressure value for 286. All other control valves in flow control module 220 are closed.

Once the valves are set to their positions, the anode chamber in cell stack 170 is pressurized with inert gas to a predetermined value, typically 5 psig, using forward-pressure regulator 258 coupled to pressure transmitter 259. Any resulting anode-to-cathode inert gas crossover leak (and the leakage rate) is then sensed by flow meter 254, communicated to control module 120 and reported on display 124.

For the cathode-to-anode leak test, inert gas supply control valve 260 is opened and control valve 263 is closed, control valve 261 is opened, control valve 264 is opened, control valves 282 and 283 are closed, back-pressure regulators 285 and 286 are fully closed by input of the maximum pressure value for 285 and 286, and back-pressure regulator 284 is fully opened (by input of a zero pressure value) for 286. All other control valves in flow control module 220 are closed.

Once the valves are set to their positions, the cathode chamber in cell stack 170 is pressurized with inert gas to a predetermined value, typically 5 psig, using forward-pressure regulator 258 coupled to pressure transmitter 259. Any resulting anode-to-cathode inert gas crossover leak rate is then sensed by flow meter 254, communicated to control module 120 and reported on display 124.

For the coolant-to-anode leak test, inert gas supply control valve 260 is opened and control valve 263 is closed, control valve 261 is opened, control valve 265 is opened, control valve 282 is opened, control valve 283 is closed, and back-pressure regulators 284, 285 and 286 are fully closed (by input of the maximum pressure value). All other control valves in flow control module 220 are closed. After that, the coolant chamber in cell stack 170 is pressurized with inert gas to a predetermined value, typically 20 psig, using forward-pressure regulator 258 coupled to pressure transmitter 259. Any resulting coolant-to-anode inert gas crossover leak (and the leakage rate) is then determined from the differential measurements of flow meters 254 and 280, which are communicated to control module 120 and reported on display 124.

For the coolant-to-cathode leak test, inert gas supply control valve 260 is opened and control valve 263 is closed, control valve 261 is opened, control valve 265 is opened, control valve 283 is opened, control valve 282 is closed, and back-pressure regulators 284, 285 and 286 are fully closed (by input of the maximum pressure value). All other control valves in flow control module 220 are closed. After that, the coolant chamber is pressurized with inert gas to a predetermined value, typically 20 psig, using forward-pressure regulator 258 coupled to pressure transmitter 259. Any resulting coolant-to-cathode inert gas crossover leak (and the leakage rate) is then determined from the measurements of flow meters 254 and 281, which are communicated to control module 120, and reported on display 124. In the case that an external leak is also present, then flow meter 254 will measure a higher value than flow meter 281; otherwise the two flow meter measurements will be similar.

For the external leak test, inert gas supply control valve 260 is opened and control valve 263 is closed, control valve 261 is opened, control valves 264, 265 and 266 are opened, control valves 282 and 283 are closed, and back-pressure regulators 284, 285 and 286 are fully closed (by input of the maximum pressure value). All other control valves in flow control module 220 are closed. After that, the anode, cathode and coolant chambers are pressurized simultaneously with inert gas to a predetermined value, typically 30 psig, using forward-pressure regulator 258 coupled to pressure transmitter 259. Any resulting inert gas external leak rate is then sensed by flow meter 254 communicated to control module 120 and reported on display 124.

Once it is determined that a leak exists somewhere within stack 170, control module 120 proceeds to conduct cell-specific leak checking. If the overall leak check does not indicate the existence of any leaks in the stack 170, control module 120 proceeds to perform the other diagnostic tests, as described later.

FIG. 2B is a block diagram of another embodiment of gas supply module 130. In this alternative embodiment, gas supply module 130 is indentical ti the embodiment described above in relation to FIG. 2A, except that control valves 268 and 270 are omitted, together with the gas lines connecting them to the coolant conduit. This alternative embodiment provides for increased safety by reducing the possibility of hydrogen and air mixing. However, in the alternative embodiment of FIG. 2B, the gas lines used in the coolant-to-anode and coolant-to-cathode open circuit voltage testing (in which hydrogen or air is supplied to the coolant conduit) must be opened and closed by manual operation of the relevant valves. Thus, in this alternative embodiment, safety is increased by reducing the possibility of explosive mixtures of air and hydrogen forming, but this is done at the expense of the full automation of system 100 that can be achieved using the embodiment described in relation to FIG. 2A.

Referring now to FIG. 3, the control module 120 is described in further detail. Control module 120 comprises a computer processor 320, a data acquisition module 330 and a memory 340 accessible to the computer processor 320.

Computer processor 320 communicates with data acquisition module 330 to transmit control signals to the valves and flow controllers in gas supply module 130 and to receive data back from the flow sensors and pressure transmitters of gas supply module 130. Thus, data acquisition module 330 provides analog to digital and digital to analog conversion to facilitate the communication of signal data between the (digital) computer processor 320 and the (analog) instrumentation, including the control valves, MFCs, pressure regulators, MFMs and pressure transmitters, of gas supply module 130.

Data acquisition module 330 may regularly sample or interrogate the flow and pressure instrumentation within gas supply module 130, storing such sample data within a dedicated memory (not shown) thereof for access by the computer processor 320 when the information is required. Alternatively, data acquisition module 330 may only temporarily buffer the digitized data from gas supply module 130 before passing it on to computer processor 320.

Computer processor 320 acts as the overall controller for the diagnostic testing system 100, communicating with other parts of the system, including data acquisition module 330, multiplexer 140, voltage monitor 150 and power supply module 160. Further, signals from user input means 122 are transmitted to the computer processor 320 for processing in a known fashion and computer processor 320 transmits display signals to display 124 for displaying graphics or other visual information to personnel operating the diagnostic testing system 100.

Computer processor 320, in its function as the overall controller for the diagnostic testing system 100, executes computer program instructions stored in memory 340. Execution of the computer program instructions causes the computer processor 320 to communicate with the various other modules or components of the diagnostic testing system 100 to carry out the testing procedures, determine the condition of the cells in the stack and generate reports regarding the condition of the cells.

Computer processor 320 may also be in communication with one or more peripheral devices, such as a printer, or may be in communication with a network via a suitable network connection (not shown). Advantageously, computer processor 320 may be in communication with a network via the network connection in order to provide diagnostic test reports to remote systems over the network or to receive controller instructions from a remote source.

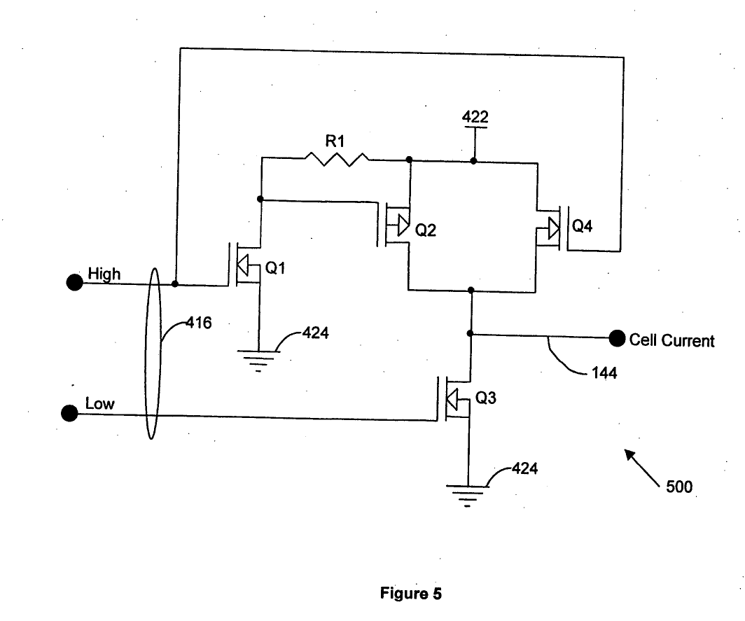

Referring now to FIG. 4, the multiplexer 140 is described in further detail. Multiplexer 140 comprises a microcontroller 410, a switching circuit block 420 comprising a plurality of current switching circuits 500 (shown in FIG. 5) and a power switching circuit 430. Microcontroller 410 is configured to provide switching control signals on switching control lines 416 to each of the switching circuits 500 in switching circuit block 420 for selectively providing current to, or sinking current from, any of cells 0 to N in the stack via stack supply conductors 144. Switching circuit block 420 receives a supply voltage from power supply module 160 via power supply circuit 430. For this purpose, mulitplexer power supply cable 142 is electrically connected between the power supply module 160 and the power supply circuit 430 of multiplexer 140.

Power supply circuit 430 comprises a power supply enable switch (first switch) SW1, which, when closed, completes a circuit between power supply module 160 and switching circuit block 420 via an active conductor 422 and a neutral conductor 424. A first fuse F1 is connected in series with switch SW1 to guard against excessive current flow through active conductor 422 when switch SW1 is closed. When switch SW1 is open, active conductor 422 is not connected to power supply module 160. Switch SW1 is opened or closed, depending on a power supply switching signal on power switching line 414 from microcontroller 410.

Power supply circuit 430 further comprises a second switch SW2, which, when closed (and SW1 is open) completes a discharge circuit with switching circuit block 420 via active conductor 422 and neutral conductor 424 through discharge resistor Rd (of about 150 Ohms). Switch SW2 is opened or closed in response to a discharge control signal on discharge control line 412 from microcontroller 410. Microcontroller 410 controls switches SW1 and SW2 so that they are not both closed at the same time. A second fuse F2 is connected in series with switch SW2 in order to prevent excessive current flow through the discharge circuit.

Microcontroller 410 transmits control signals on lines 412, 414 and 416 in response to corresponding instructions transmitted from control module 120 during operation of the diagnostic testing system 100. For example, when, as part of the short-circuit testing, a voltage is to be applied across the cells of the stack, control module 120 issues an appropriate command, for example via an RS-232 connection, to microcontroller 410, which closes switch SW1, opens switch SW2 (if not already open) and provides switching control signals on lines 416 to the switching circuits in switching circuit block 420 to provide a voltage across the cells of the stack via a stack power supply conductors 144. Individual cell voltages are then measured by the voltage monitor 150, as described later.

Power supplied to power supply circuit 430 from power supply module 160 via multiplexer power supply cable 142 is controlled by computer processor 320 to supply voltages or currents of greater or lesser magnitudes, depending on the testing requirements. For this purpose, the computer processor 320 of control module 120 communicates, preferably via a general purpose interface bus (GPIB), with power supply module 160 to set the output current and/or voltage level of power supply circuit 430. Advantageously, switching circuits 500 are configured to provide small voltages to the cells, as well as higher voltages in response to corresponding current or voltage levels at power supply circuit 430.

Typically, when using logic controlled MOSFETs, the voltage level would be around 2.7 volts. In multiplexer 140, it is desirable to have current switching circuitry that can operate above 2.7 volts (when a group of cells is being tested) and can alternatively operate below 2.7 volts (when only one or two cells are being tested). This can be done using the switching circuits 500 as described below.

Advantageously, multiplexer 140 can selectively provide current or voltage to any cell within the stack by selectively switching on the corresponding switching circuit 500 for that cell. Similarly, current or voltage may be supplied to one or more selected groups of cells, thus allowing the diagnostic testing to focus on specific cells or groups of cells. Further, switching circuit block 420 may have a large number of switching circuits 500, for example, more than a hundred, allowing large stacks to be tested and allowing high currents, for example, up to about 8 amps, to be passed through the switching circuits 500.

Once testing of a cell or group of cells is completed, control module 120 issues an appropriate command to microcontroller 410, which transmits an “OPEN” power supply switching signal 414 to open switch SW1 and transmits an appropriate “CLOSE” discharge control signal 412 to close switch SW2, thereby completing the discharge circuit and allowing current remaining in the tested cells to be discharged through resister Rd.

Referring now to FIG. 5, one of the plurality of switching circuits 500 is shown and described in further detail. Switching control signals 416 may be received at each of switching circuits 500 at either a “high” signal line or a “low” signal line of the switching circuit 500. Supply voltage is received by each switching circuit 500 from active conductor 422 when switch SW1 is closed. Each switching circuit 500 is effectively “grounded” by a connection to neutral conductor 424, which is connected to the negative terminal of the power supply of power supply module 160. Each switching circuit 500 has an output conductor corresponding to one of the stack power supply conductors 144.

The high and low signal lines of each switching circuit 500 effectively select the operating mode for that circuit. If the high signal line is active, the switching circuit 500 acts as a current source. However, if the low signal line is active, the switching circuit 500 acts as a current sink. The high and low signal lines cannot be both active at the same time. However, if neither of the high or low signal lines is active, the switching circuit 500 is effectively inoperative or “switched off”.

The low signal line is connected to the gate of a transistor Q3, such that, when the low signal line is active, transistor Q3, which is an N-channel MOSFET (metal-oxide semiconductor field-effect transistor), is enabled, effectively drawing current from the corresponding cell to ground (although this is actually to neutral conductor 424).

For switching circuit 500 to operate as a current source, the high signal line must be active. If the input voltage on voltage supply conductor 422 is relatively large, for example in the order of 50 volts, transistor Q1, which is an N-channel MOSFET, and transistor Q2, which is a P-channel MOSFET, which are together formed as a load switch, will operate to draw current through transistor Q2 to stack supply conductor 144. As the low signal line is inactive, transistor Q3 is disabled and does not sink the current drawn-though transistor Q2.

The load switch configuration formed by transistors Q1 and Q2 also comprises a resistor R1 connected between the high potential side of transistor Q2 and the high potential side of transistor 01. The gate of transistor Q2 is connected to the high potential side (drain) of transistor Q1. Resistor R1 is a biasing resistor that pulls up the gate of transistor 02 to the level of the supply voltage 422. This effectively maintains transistor Q2 in a disabled state, unless transistor Q1 pulls the gate of transistor Q2 to ground.

If the voltage of supply voltage 422 is large enough (for example, above about 2.7 volts) to polarize transistor Q2, it will let current flow, as long as transistor Q1 is enabled by the high signal line. However, if supply voltage 422 is relatively small (for example, below about 2.7 volts), then transistor Q4, which is an N-channel MOSFET, will be enabled by the high signal line instead and will supply current to stack supply conductor 144.

With the described configuration, switching circuit 500 can source current from a range of supply voltages on active supply conductor 422, limited only by the breakdown voltages of the various transistors. Being able to source current from a range of voltages on active supply conductor 422 is important as various voltage or current levels will be required to be supplied to stack supply conductors 144 during the diagnostic testing. For example, for a single cell test, the voltage can be as low as 0.3 volts, whereas for a group of cells or even for an entire stack, the voltage requirement may exceed 50 volts.

It will be understood that switching circuit 500 can be implemented in forms other than those shown in FIG. 5 and described in relation thereto. For example, the polarity of the circuit may be reversed, if desired, and P-channel MOSFETs can be used in place of N-channel MOSFETs and vice-versa, providing that the switching circuit 500 thus modified can switchably supply or sink current and/or voltage to the cells of an electrochemical cell stack. Further, any modified versions of switching circuit 500 should still allow current to be supplied to the cell from a relatively wide range of supply voltages on the supply conductor.

Referring now to FIG. 6, voltage monitor 150 is described in further detail. Voltage monitor 150 is electrically connected between control module 120 and fuel cell stack 170. Between control module 120 and voltage monitor 150, the electrical connection is provided by a communication cable or other communication connection. Voltage monitor 150 is connected to fuel cell stack 170 by a plurality of voltage sensing conductors 650. Voltage sensing conductors 650 are connected to fuel cell stack 170 so as to measure the electrical potential between the anode and cathode plates of each cell.

A voltage monitor analogous to voltage monitor 150 is described in commonly owned co-pending U.S. patent application Ser. No. 09/865,562, filed May 29, 2001, the entire disclosure of which is hereby incorporated by reference. U.S. patent application Ser. No. 09/865,562 is published under US Publication No. 2002-0180447-A1. Another voltage monitor analogous to voltage monitor 150 is described in commonly owned co-pending U.S. patent application Ser. No. 10/845,191, filed May 13, 2004, the entire disclosure of which is hereby incorporated by reference. Other forms of voltage monitor 150 may be employed, providing that they have the described features and perform the described functions.

As shown in FIG. 6, voltage-sensing conductors 650 connect to the fuel cell stack 170 at a voltage measuring assembly 660. Voltage measuring assembly 660 is described in commonly owned co-pending U.S. patent application Ser. No. 10/778,322, filed Feb. 17, 2004, the entire disclosure of which is hereby incorporated by reference.

The voltage measuring assembly 660 extends parallel to the longitudinal direction of the fuel cell stack 170 and is mounted, at two ends thereof, on the side faces of two end plates of the fuel cell stack 170. The voltage measuring assembly 660 generally comprises a printed circuit board (PCB) (not shown) and a plurality of probes (not shown) detachably secured, for example, by soldering, in a plurality of pinholes (not shown) in the PCB.

The pinholes are formed in a plurality of groups. For example, each pinhole group may consist of three pinholes. The pinholes in each group are electrically connected with one another but each group of pinholes is not in electrical connection with any other group of pinholes. Each group of pinholes is electrically connected to a multi-pin connector (not shown) secured, for example, by soldering, on the PCB via printed circuits (not shown).

One or more such multi-pin connectors may be provided on the PCB and are used to provide an electrical connection with external circuits for analyzing fuel cell voltages measured by the voltage measuring assembly 660. Thus, voltage sensing conductors 650 are coupled to the multi-pin connectors of voltage measuring assembly 660, for example using one or more corresponding wiring harness connectors.

Voltage monitor 150 comprises a controller 610, an analog to digital converter 620, a multiplexer 630 and a series of differential amplifiers 640. Differential amplifiers 640 are connected to voltage sensing conductors 650. Each of the differential amplifiers reads the voltages at two terminals (usually the anode and cathode) of each fuel cell. The differential amplifiers 640 provide an output indicative of the potential difference between the two terminals and this output is provided to the analog to digital converter 620 via multiplexer 630.

Thus, the analog to digital converter 620 reads the output of the differential amplifiers 640 via the multiplexer 630, which provides access to one of the differential amplifiers 640 at any given time. The analog to digital converter 620 may thus poll differential amplifiers 640 in a rapid sequence using multiplexer 630 to sequentially select each of the differential amplifiers 640.

The digital output of the analog to digital converter 620 (in the form of quantized voltage measurements) is provided to controller 610 for processing. The controller 610 controls the operation of the analog to digital converter 620 and the multiplexer 630, processes the digital output it receives and executes software instructions for communicating the received voltage measurements to control module 120. Controller 610 requires relatively little processing capability as much of the processing of the voltage measurement information is performed by computer processor 320 within control module 120. However, controller 610 preferably includes a memory (not shown) for storing any program code necessary for performing its voltage information gathering function.

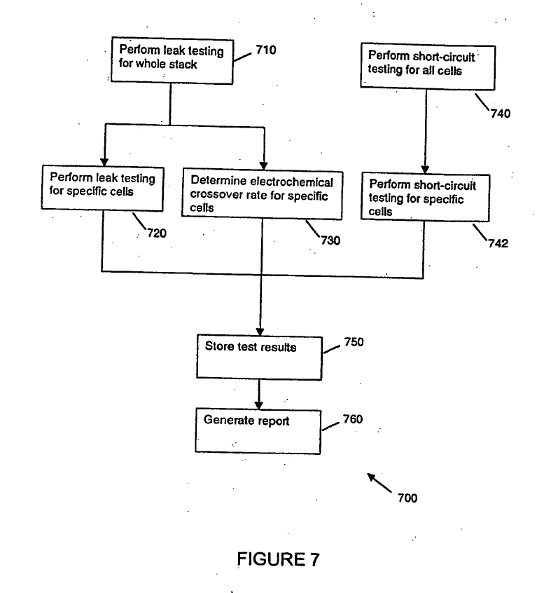

Referring now to FIG. 7, a diagnostic testing method 700 is described in further detail. Diagnostic testing method 700 uses diagnostic testing system 100 and the components thereof to perform diagnostic testing of fuel cell stack 170. Accordingly, method 700 will be described with reference to the steps shown in FIG. 7 and the components of diagnostic testing system 100 shown in FIGS. 1 to 6.

Once gas supply lines 132, power supply conductors 144 and voltage sensing conductors 650 are connected to fuel cell stack 170, testing of the fuel cell stack 170 may commence. Method 700 begins at step 710, in which leak testing of the whole stack is performed, as previously described in relation to FIG. 2. If it is determined that there is a gas leak within the stack, the stack is tested, at step 720, to determine the specific cells which are affected by the leakage. If the leak testing performed at step 710 did not indicate any gas leakage within the stack, step 720 is not performed.

Leak testing of specific cells at step 720 is performed as a coolant-to-anode crossover leak test, a coolant-to-cathode crossover leak test or, at step 730, as part of an electrochemical (hydrogen) crossover test between the anode and cathode chambers of the cells.

To test the coolant-to-anode crossover, inert gas is supplied from the gas supply module 130 to the coolant conduit inlet of the stack while blocking the coolant outlet. Air is then supplied from gas supply module 130 to the cathode conduit at a rate of about 2 mL/min/cm²/cell with no back pressure, heating or humidification. Similarly, hydrogen is supplied to the anode conduit of fuel cell stack 170 from gas supply module 130, at a rate of about 0.5 mL/min/cm²/cell with no back pressure, heating or humidification. The inert gas pressure at the coolant inlet is increased to about 20 psig.

With the gases being supplied to the stack as described, the voltage monitor 150 is used to measure the cell voltages. Those cells indicating a substantially lower open circuit voltage than the other cells are determined to have a coolant to anode crossover leak. This is because any inert gas leaking from the coolant chamber of a cell to the anode chamber will dilute the hydrogen at the anode and cause the cell voltage to drop.

It is known from the overall leak testing (step 710) whether the leak is a coolant-to-anode or a coolant-to-cathode crossover leak and the cell-specific testing at step 720 is performed accordingly.

The coolant-to-anode and coolant-to-cathode crossover tests are preferably checked by another testing method, as follows. For the coolant-to-anode crossover test, the gas supply module 130 provides hydrogen to the coolant conduit at a rate of about 2 mL/min/cm²/cell, while providing inert gas to the anode conduit of the stack at about 0.5 mL/min/cm²/cell and air is provided to the cathode conduit of the stack at about 2 mL/min/cm2/cell. With the normal gas supply of the anode and coolant conduits being swapped, voltage monitor 150 measures the potential differences between the cells. In such conditions, the potential differences should be low in the absence of a leak.

Control module 120 receives the voltage measurements from voltage monitor 150 and determines whether any of the cells has a large or increasing open circuit voltage relative to the other cells, thus indicating that the hydrogen fuel gas is crossing over from the coolant chamber of such cells to the anode chamber.

The secondary coolant-to-cathode leak test is similar to that described above for the secondary coolant-to-anode leak test, except that voltage monitor 150 measures the cell voltages while air is supplied to the coolant conduit, inert gas is supplied to the cathode conduit and hydrogen is supplied to the anode conduit. Thus, if air crosses over from the coolant chamber to the cathode chamber of a cell, the cell will generate a larger or increasing open circuit voltage relative to the other cells.

In order to determine the likelihood of existence of such a coolant-to-anode or coolant-to-cathode leak, control module 120 performs a comparison of the relative values of the cell voltages and, if the difference is large enough (i.e. above a pre-determined threshold) or if the difference in rate of change of cell voltages is large enough, the control module 120 determines that the cell is affected by a leak from its coolant chamber into its anode chamber or cathode chamber, as appropriate.

In step 730, control module 120 determines the electrochemical crossover (i.e. leakage) rate between the anode and cathode chambers of these cells. This is performed in a roughly similar manner to the coolant-to-anode or coolant-to-cathode crossover leak testing of step 720. However, for step 730, hydrogen is supplied to the anode conduit and nitrogen or another inert gas is supplied to the cathode conduit. Also, for the cells undergoing the electrochemical (hydrogen) crossover test, multiplexer 140 supplies a voltage to those cells.

During the testing step 730, control module 120 controls power supply module 160 so as to incrementally increase the voltage supplied to power supply circuit 430 of multiplexer 140, which in turn increases the current through switching circuits 500, while voltage monitor 150 measures the voltages across each of the cells. The cell current through the cells is measured by the multimeter within the power supply module 160. Alternatively, a separate multimeter may be used in-line with the power supply module 160. Such a separate multimeter would communicate with control module 120 via a GPIB (bus).

If the current of a cell varies sharply with the input voltage to that cell, electrical shorting of the cell is indicated. On the other hand, if the current is substantially constant as the input voltage varies, it is determined that no electrical shorting affects the cell. The level of the constant current corresponds to the hydrogen crossover rate and, accordingly, the crossover rate (in slpm) may be determined by multiplying the constant current value by a constant conversion factor.

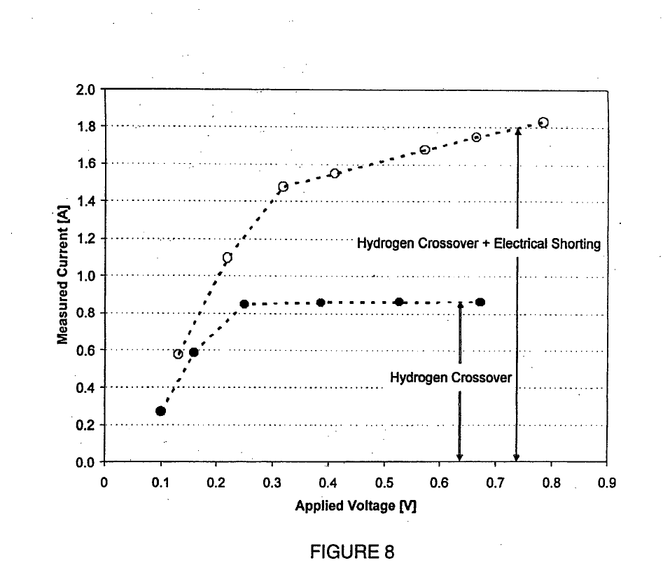

Example test data are shown in FIG. 8, plotted according to measured current on the vertical axis and applied voltage on the hotizontal axis. As illustrated in FIG. 8 by the lower curve (shown by solid data points), the data points of a plotted voltage-current characteristic may indicate a constant current region. The level of the constant current region is then used to calculate the Hydrogen crossover rate. If the cell being tested is also subject to electrical short-circuiting, the voltage-current characteristic will not remain constant. Instead, it will show a strong linear dependence of measured current on the applied voltage in a region in which it would otherwise remain constant. This is illustrated in FIG. 8 by the upper curve (shown by hollow data points). If such a region of strong linear dependence is found in the voltage-current characteristic for a cell, the control module 120 determines that there is likely to be a short-circuit of the cell in addition to a degree of Hydrogen crossover. The Hydroen crossover rate of such a cell is then determined following the short-circuit testing (described below in relation to step 742) by subtracting from the voltage-current characteristic the component thereof due to the short-circuit affecting that cell.

In step 740, short-circuit testing of (preferably all of) the cells of fuel cell stack 170 is performed. Step 740 is performed by supplying inert gas or air to the anode and cathode conduits of the stack, while supplying a voltage across the cells to be tested by multiplexer 140. Simultaneously, voltage monitor 150 monitors the open-circuit potential across the anode and cathode plates of each cell. Initially, the voltage applied across these cells by multiplexer 140 is relatively small, but increases incrementally to a normal cell operating voltage level between about 0.5 to 1.0 volts. Those cells measured to have a substantially lower open circuit potential between their anode and cathode plates, relative to the other cells, are determined to be short-circuited, or at least likely to be short-circuited. This is described in further detail in U.S. application Ser. No. 10/845,191.

For cells determined in step 740 to be likely to be short-circuited, each such cell may be subjected, at step 742, to further testing to determine the degree of short-circuit affecting that cell. This is preferably done by supplying voltage to the affected cells using power supply module 160 through multiplexer 140 and measuring the current characteristics of the cells in the absence of any reactant gases.

Before supplying the inert gas or air to the fuel cell stack 170 for the short-circuit testing, the stack is preferably flushed with a nitrogen (or other inert gas) purge. Similarly, with the other testing steps 710, 720 and 730, the stack conduits and cells are preferably purged or flushed so that none of the testing procedures are contaminated by gases or reaction byproducts resulting from earlier tests or operations. Additionally, after each test procedure in which multiplexer 140 provides current or voltage to fuel cell stack 170, microcontroller 410 closes switch SW2 and opens switch SW1 and thereby discharges any residual current in the cells through discharge resistor Rd. Such discharge is also required in the case where the stack is electronically charged by flow of reactants during coolant-to-anode/cathode open-circuit voltage testing, which does not use multiplexer 140.

Following testing steps 710 to 740 (and step 742, if necessary), the results of the testing are stored within memory 340, at step 750 and, at step 760, the stored tested results are used to generate a diagnostic test report for review on display 124 or via a peripheral device such as a printer. The diagnostic test report may include the measured test results and determinations made by control module 120, based on the test results.

Certain of the steps of method 700 may be performed independently of each other. For example, steps 710, 720 and 730 may be performed before or after steps 740 and 742. However, steps 740 and 742 are preferably performed after steps 710 to 730. Similarly, steps 720 and 730 are preferably performed independently of each other. Step 730 may be performed before or after step 720.

While the diagnostic testing systems and methods have been described herein with reference to hydrogen fuel cells, it is understood that the described methods and systems are equally applicable to diagnostic testing of electrolyzer cells and electrolyzer cell stacks.

Various modifications or enhancements may be made to the described embodiments, without departing from the spirit and scope of the invention.

1. Apparatus for diagnostic testing of an electrochemical cell stack, each cell of the stack having an anode plate, a cathode plate and a membrane therebetween, the apparatus comprising:
a multiplexer for switching current to one or more cells in the electrochemical cell stack;
a voltage monitor for monitoring the voltage between the anode plate and the cathode plate of one or more cells;
a power supply module for supplying power to the multiplexer;
a gas supply module for supplying fuel gas and non-fuel gas to the electrochemical cell stack; and
a control module electrically connected to, and configured to control, the multiplexer, the voltage monitor, the power supply module and the gas supply module to conduct automatic diagnostic testing of the electrochemical cell stack and to determine, through the diagnostic testing, whether the electrochemical cell stack has one or more gas leaks and, if so, which of the one or more cells is affected by the one or more gas leaks, a degree of crossover of electrochemical reactant through the membrane of each cell and whether any of the cells is likely to be short-circuited.

2. The apparatus of claim 1, wherein the control module comprises a computer processor having access to stored computer program instructions which, when executed by the computer processor, cause the control module to automatically conduct the diagnostic testing.

3. The apparatus of claim 1, wherein the gas supply module comprises a plurality of gas supply lines connectible to the electrochemical cell stack for supplying gas to one or more of an anode conduit, a cathode conduit or a coolant conduit of the electrochemical cell stack, and wherein each gas supply line has at least one control valve associated therewith for controlling gas flow in the respective gas supply line, each control valve being configured to open or close in response to respective valve control signals transmitted from the control module.

4. The apparatus of claim 3, wherein the gas supply module comprises respective flow sensors at respective outlets of the anode and cathode conduits and wherein the control module is configured to control the gas supply module to supply non-fuel gas to the electrochemical cell stack via the gas supply lines when the control valves are in a predetermined operating configuration and to determine from an output of one or more of the flow sensors the existence of one or more gas leaks in the electrochemical cell stack.

5. The apparatus of claim 4, wherein the control module is configured to operate the control valves and the gas supply lines to perform one or more of a series of leak tests, including: anode chamber to cathode chamber leak testing; cathode chamber to anode chamber leak testing; coolant chamber to anode chamber leak testing; coolant chamber to cathode chamber leak testing; and leak testing between all chambers and an external environment.

6. The apparatus of claim 5, wherein all of the series of leak tests are performed sequentially.

7. The apparatus of claim 1, wherein the multiplexer comprises:
a microcontroller;
a power supply circuit responsive to power control signals from the microcontroller; and
a plurality of switching circuits receiving power from the power supply circuit responsive to the power control signals from the microcontroller, each switching circuit switchably supplying current, responsive to switching control signals from the microcontroller, to respective electrochemical cells during the diagnostic testing.

8. The apparatus of claim 7, wherein the switching circuits each comprise transistors having a high current tolerance.

9. The apparatus of claim 8, wherein the transistors are MOSFETs.

10. The apparatus of claim 7, wherein the power supply circuit comprises a first power switch for supplying power to the switching circuits when the first power switch is closed, the first power switch being operable to open or close in response to a first power control signal from the microcontroller.

11. The apparatus of claim 10, wherein the power supply circuit comprises a second power switch for discharging current from the electrochemical cells when the first power switch is open and the second power switch is closed, the second power switch being operable to open or close in response to a second power control signal from the microcontroller and wherein the power supply circuit further comprises a discharge resistor connected in series with the second power switch.

12. The apparatus of claim 7, wherein each switching circuit is configured to receive a varying input voltage and to output a correspondingly varying output current to a respective electrochemical cell.

13. The apparatus of claim 7, wherein the microcontroller is configured to output a first switching signal or a second switching signal to each switching circuit, whereby, when the microcontroller outputs the first switching signal to one of the switching circuits, that switching circuit is enabled to supply current to the respective electrochemical cell and, when the microcontroller outputs the second switching signal to one of the switching circuits, that switching circuit is enabled to sink current from the respective electrochemical cell.

14. The apparatus of claim 13, wherein, depending on the input voltage of the switching circuit, the first switching signal enables first and second transistors or a third transistor and where, when the input voltage is small, the first and second transistors operate to pass current to the respective electrochemical cell via the second transistor and, when the input voltage is large, the third transistor operates to pass current to the respective electrochemical cell.

15. The apparatus of claim 13, wherein the second switching signal enables a fourth transistor to sink current from the respective electrochemical cell.

16. The apparatus of claim 1, wherein the voltage monitor comprises a plurality of voltage sensing conductors respectively connected to the anode and cathode plates of each cell of the electrochemical cell stack, and wherein the voltage monitor further comprises a plurality of differential amplifiers arranged to detect a voltage difference between the voltage sensing conductors connected to respective anode and cathode plates of the cells.

17. The apparatus of claim 16, wherein the voltage monitor further comprises a multiplexer, an analog to digital converter and a controller, wherein the multiplexer polls the differential amplifiers successively to determine the voltage differences between the anode and cathode plates of the cells, the analog to digital converter converts the voltage differences from an analog value to a digital voltage value and the controller receives the digital voltage values from the analog to digital converter and communicates the digital voltage values to the control module.

18. The apparatus of claim 16, further comprising a voltage measuring assembly interconnecting the voltage sensing conductors and the electrochemical cell stack.

19. The apparatus of claim 18, wherein the voltage measuring assembly comprises a printed circuit board (PCB) and a plurality of probes for contacting respective electrodes of the electrochemical cell stack, the probes eing electrically connected to the voltage sensing conductors.

20. The apparatus of claim 19, wherein the probes are connected to the voltage sensing conductors via at least one multi-pin connector.

21. The apparatus of claim 3, further comprising a housing, the housing housing the multiplexer, the voltage monitor, the power supply module, the gas supply module and the control module and having the gas supply lines extending therefrom for connection to the electrochemical cell stack.

22. The apparatus of claim 1, wherein the control module comprises a computer processor and a data acquisition module for interfacing between the gas supply module and the computer processor.

23. The apparatus of claim 22, wherein the data acquisition module is configured to receive instrument control signals from the computer processor and to transmit corresponding instrument control signals to instruments in the gas supply module and is further configured to receive measurement signals from measurement devices in the gas supply module and to transmit corresponding measurement signals to the computer processor.

24. The apparatus of claim 3, wherein the gas supply module comprises:
a gas supply of at least Hydrogen, inert gas and air;
a flow control module connected to the gas supply for controlling the supply of gas from the gas supply to one or more of the anode conduit, the cathode conduit and the coolant conduit of the electrochemical cell stack during the diagnostic testing; and
a flow outlet module connected to an outlet side of the electrochemical cell stack for sensing and controlling gas flow from the outlet side.

25. A method of automated diagnostic testing of an electrochemical cell stack having a plurality of cells, each cell in the electrochemical cell stack having an anode plate, a cathode plate and a membrane therebetween and the electrochemical cell stack defining, for each cell, an anode chamber, a cathode chamber and a coolant chamber, the method comprising the steps of:
a) selectively providing non-fuel gas to one or more of the anode chamber, the cathode chamber and the coolant chamber;
b) sensing a gas flow of the non-fuel gas through a selected one or more of the anode chamber, the cathode chamber and the coolant chamber to determine whether there is at least one gas leak from one or more of the anode chamber, the cathode chamber and the coolant chamber;
c) if it is determined in step b) that there is at least one gas leak, determining which cells are affected by the at least one gas leak by performing the steps of:
i) selectively supplying fuel and/or non-fuel gas to one or more of the anode chamber, the cathode chamber and the coolant chamber,
ii) measuring relative current and/or voltage characteristics of the cells, and
iii) determining, for each cell, the likelihood of the cell being affected by the at least one gas leak based on the measured current and/or voltage characteristics;
d) supplying non-fuel gas to the anode chamber and the cathode chamber;
e) applying a voltage across selected cells;
f) measuring the open-circuit potential across the anode and cathode plates of each of the selected cells;
g) determining whether each of the selected cells is short-circuited based on the measured open-circuit potential of the cell relative to the measured open-circuit potential of other selected cells;
h) storing test data and determinations generated in steps b), c), f) and g); and
i) generating a diagnostic report based on the test data and determinations.

26. The method of claim 25, wherein if in step b) it is determined that there is at least one gas leak between the anode and coolant chambers or between the cathode and coolant chambers, step c) ii) comprises measuring the potential difference between the anode plate and cathode plate of each cell.

27. The method of claim 25, wherein if in step b) it is determined that there is at least one gas leak between the anode chamber and the cathode chamber, step c) further comprises the step of: i) A) applying a voltage across selected cells; and step c) ii) comprises measuring the relative current and voltage characteristics of the selected cells.
